(19) United States
(12) Patent Application Publication
(10) Pub. No.: US 2013/0158204 A1
(43) Pub. Date: Jun. 20, 2013

(54) RUBBER COMPOSITION FOR GOLF BALLS, AND METHOD OF MANUFACTURING GOLF BALLS

(71) Applicant: BRIDGESTONE SPORTS CO., LTD., Tokyo (JP)

(72) Inventor: Yuichiro OZAWA, Chichibushi (JP)

(73) Assignee: BRIDGESTONE SPORTS CO., LTD., Tokyo (JP)

(21) Appl. No.: 13/675,373

(22) Filed: Nov. 13, 2012

(30) Foreign Application Priority Data
Dec. 15, 2011 (JP) 2011-274101

(51) Int. Cl. C08L 9/00

(52) U.S. Cl. CPC C08L 9/00
USPC 525/301

(57) ABSTRACT

One-piece golf balls or golf ball cores are obtained by molding and vulcanizing a rubber composition which includes (A) a polybutadiene-containing base rubber and (B) methacrylic acid. By including in the rubber composition (C) from 0.1 to 0.5 part by weight of a maleimide per 100 parts by weight of component A, the vulcanization time during molding and vulcanization is shortened, which enhances productivity without altering the performance and properties of the molded and vulcanized material.

### CROSS-REFERENCE TO RELATED APPLICATION

This non-provisional application claims priority under 35 U.S.C. §119(a) on Patent Application No. 2011-274101 filed in Japan on Dec. 15, 2011, the entire contents of which are hereby incorporated by reference.

### BACKGROUND OF THE INVENTION

The present invention relates to a rubber composition for use in one-piece golf balls and the cores of solid golf balls such as two-piece golf balls and multi-piece golf balls, and relates also to a method of manufacturing such golf balls. More specifically, the invention relates to a rubber composition for golf balls and a golf ball manufacturing method which are able, by shortening the vulcanization time, to improve productivity while retaining a good performance.

One-piece golf balls, and the solid cores of two-piece golf balls and multi-piece golf balls having a solid core encased, either directly or over an intervening intermediate layer, by a cover, are generally obtained by vulcanizing a rubber composition which includes as the base material a rubber component such as polybutadiene and also includes, for example, an unsaturated carboxylic acid metal salt such as zinc acrylate and an organic peroxide. The unsaturated carboxylic acid metal salt serves primarily as a co-crosslinking agent or a crosslinking aid in the rubber composition, and is known to have a large influence on the crosslink structure and crosslink density of the rubber.

Peroxide crosslinking is used to crosslink rubber, and is carried out with one or more organic peroxide. In recent years, there exist in the field of golf balls numerous prior art disclosures which employ two or more organic peroxides by taking advantage of the difference in the decomposition temperatures of the organic peroxides. A variety of research has been conducted on such peroxide crosslinking.

In addition to these organic peroxides and unsaturated carboxylic acid metal salts, various types of additives, such as antioxidants, sulfur, organosulfur compounds, inert fillers and zinc stearate, are also suitably included in such rubber compositions for golf balls in order to improve the physical properties and characteristics thereof.

However, there exists a desire for improved performance in golf balls and also a desire to cut production costs by enhancing productivity without sacrificing performance. Prior art relating to the present invention is disclosed in, for example, JP-A 57-078876, JP-A 06-504688, JP-A 05-345050 and JP-A 07-048477.

It is therefore an object of this invention to provide, on the basis of further investigations on various additives included in rubber compositions, a rubber composition for golf balls and a method of manufacturing golf balls which are able to enhance the productivity of molded and vulcanized bodies without lowering performance.

### SUMMARY OF THE INVENTION

I have discovered that, in preparing a rubber composition for use in forming one-piece solid golf balls or the cores or other portions of solid golf balls having a cover of one or more layer, when an unsaturated carboxylic acid is compounded with a polybutadiene-containing base rubber and a molded and crosslinked material is obtained therefrom using a crosslinking agent such as an organic peroxide, by employing methacrylic acid as the unsaturated carboxylic acid and by also including a maleimide in the rubber composition and optimizing the amount of maleimide, the vulcanization time can be shortened without substantially altering the performance and properties of the molded and crosslinked material, thus enabling the golf ball productivity to be effectively improved.

Accordingly, in a first aspect, the invention provides a rubber composition for golf balls, which composition includes (A) a polybutadiene-containing base rubber, (B) methacrylic acid, and (C) a maleimide. Component C is included in an amount of from 0.1 to 0.5 part by weight per 100 parts by weight of component A.

The maleimide serving as component C is preferably a monomaleimide of general formula (1) below

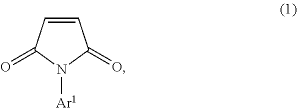

or a bismaleimide of general formula (2) below

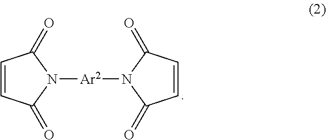

In formulas (1) and (2), Ar¹ is a hydrogen atom or an aryl group, and Ar² is an arylene group.

The maleimide of component C is more preferably N,N′-m-phenylenebismaleimide.

The rubber composition preferably includes also, as a crosslinking agent, (D) an organic peroxide.

The rubber composition is typically adapted for use in forming a golf ball core or a one-piece golf ball.

In a second aspect, the invention provides a method of manufacturing golf balls that includes the step of molding and vulcanizing a rubber composition which includes (A) a polybutadiene-containing base rubber and (B) methacrylic acid so as to obtain a golf ball core or a one-piece golf ball. The vulcanization time during molding and vulcanizing is shortened by including in the rubber composition (C) from 0.1 to 0.5 part by weight of a maleimide per 100 parts by weight of component A.

In this golf ball manufacturing method, the maleimide of component C is preferably a monomaleimide of general formula (1) below

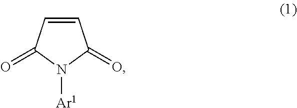

or a bismaleimide of general formula (2) below

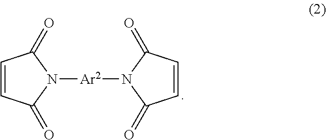

In formulas (1) and (2), Ar¹ is a hydrogen atom or an aryl group, and Ar² is an arylene group.

The maleimide of component C is preferably N,N′-m-phenylenebismaleimide.

Preferably, in the golf ball manufacturing method, the rubber composition further includes, as a crosslinking agent, (D) an organic peroxide.

The rubber composition for golf balls and the method of manufacturing golf balls of the invention enable golf balls having a good performance to be manufactured at a good productivity.

### DETAILED DESCRIPTION OF THE INVENTION

The objects, features and advantages of the invention will become more apparent from the following detailed description.

The inventive rubber composition for golf balls is a rubber composition obtained by compounding (A) a base rubber, (B) an unsaturated carboxylic acid, and (C) a maleimide. Formulation of the rubber composition is described in detail below.

Polybutadiene is used as the base rubber serving as component A. In particular, it is recommended that use be made of a polybutadiene having a cis-1,4 bond content on the polymer chain of at least 60 wt %, preferably at least 80 wt %, more preferably at least 90 wt %, and most preferably at least 95 wt %. If the content of cis-1,4 bonds among the bonds on the molecule is too low, the resilience may decrease.

The content of 1,2-vinyl bonds on the polybutadiene is preferably not more than 2 wt %, more preferably not more than 1.7 wt %, and even more preferably not more than 1.5 wt %, of the bonds on the polymer chain. If the content of 1,2-vinyl bonds is too high, the resilience may decrease.

Rubber ingredients other than the above polybutadiene may be included in above component A within a range that is not detrimental to the advantageous effects of the invention. Examples of such rubber ingredients include diene rubbers other than the above polybutadiene, such as styrene-butadiene rubber, natural rubber, isoprene rubber and ethylene-propylene-diene rubber.

The unsaturated carboxylic acid serving as component B is included as a co-crosslinking agent. In this invention, methacrylic acid is used as component B.

When use is made here of other unsaturated carboxylic acids commonly employed as co-crosslinking agents, such as acrylic acid, maleic acid, fumaric acid or metal salts of unsaturated carboxylic acids (e.g., zinc salts and magnesium salts), undesirable effects such as a lower durability arise, making it impossible to achieve the objects of the invention.

The amount of methacrylic acid (as component B) included per 100 parts by weight of the base rubber may be set to preferably at least 5 parts by weight, and more preferably at least 10 parts by weight. The upper limit in the amount of methacrylic acid included per 100 parts by weight of the base rubber may be set to preferably not more than 50 parts by weight, and more preferably not more than 40 parts by weight. If too much is included, the ball may become too hard, which may result in an unpleasant feel at impact. On the other hand, if too little is included, the feel at impact may be too soft or the durability may decrease.

The maleimide serving as component C is not subject to any particular limitation, although preferred use may be made of a monomaleimide of general formula (1) below

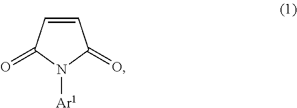

or a bismaleimide of general formula (2) below

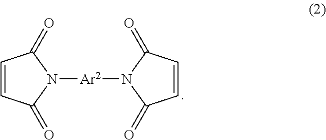

In the above formulas, Ar¹ is a hydrogen atom or an aryl group, and Ar² is an arylene group.

As noted above, Ar¹ in formula (1) represents a hydrogen atom or an aryl group. Some or all of the hydrogen atoms on the aryl group may be substituted. Exemplary aryl groups include carboxyphenyl groups, hydroxyphenyl groups, methylphenyl groups and chlorophenyl groups. Ar² in formula (2) represents an arylene group. Some or all of the hydrogen atoms on the arylene group may be substituted. Preferred examples of the arylene group include phenylene groups, methylphenylene groups and diphenylmethane groups.

Illustrative examples of the monomaleimide of general formula (1) include p-carboxyphenyl maleimide, p-hydroxyphenyl maleimide, o-methylphenyl maleimide and o-chlorophenyl maleimide. Illustrative examples of the bismaleimide of general formula (2) include N,N′-m-phenylenebismaleimide, 4-methyl-1,3-phenylenebismaleimide and 4,4′-diphenylmethanebismaleimide. Of these, the use of N,N′-m-phenylenebismaleimide, shown in formula (3) below, is preferred.

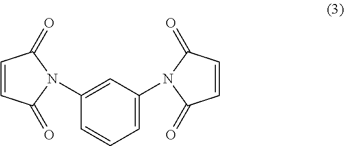

The amount of maleimide included as component C in the rubber composition, although not particularly limited, is typically set to from 0.1 to 0.5 part by weight per 100 parts by weight of component A. At less than 0.1 part by weight, a sufficient vulcanization time shortening effect may not be obtained, as a result of which the object herein of enhancing the production efficiency may not be achieved. On the other hand, at more than 0.5 part by weight, the vulcanization time is shortened, but the molded and vulcanized material obtained may incur large changes in deflection. When such a material is used as, for example, the core of a golf ball, the ball performance may be strongly affected, as a result of which the object of the invention may not be achievable. The lower limit in the amount of maleimide included is more preferably at least 0.2.

A known crosslinking agent may be included in the inventive rubber composition. Although not subject to any particular limitation, in the invention, it is preferable to use (D) an organic peroxide for this purpose. Known organic peroxides may be used without particular limitation as the crosslinking agent. Illustrative examples include dicumyl peroxide, 1,1-di(t-butylperoxy)cyclohexane, dibenzoyl peroxide, dilauroyl peroxide and 1,1-bis(t-butylperoxy)-3,3,5-trimethylcyclohexane. These may be used singly or as combinations of two or more thereof. Commercial products may be used as these organic peroxides. Illustrative examples of such commercial products include those available under the trade names “Percumyl D” and “Perhexa C-40” (both from NOF Corporation), the trade names “Niger BW” and “Peroyl L” (both from NOF Corporation), and the trade name “Trigonox 29” (from Kayaku Akzo Corporation).

The amount of organic peroxide (component D) included is suitably set according to, for example, the type of organic peroxide and the molding and crosslinking conditions that are selected. Although not subject to any particular limitation, the amount included per 100 parts by weight of component A is preferably at least 0.1 part by weight, and more preferably at least 0.3 part by weight. The upper limit is preferably not more than 5 parts by weight, and more preferably not more than 3 parts by weight. If too little organic peroxide is included as component D, the feel at impact may be too soft. On the other hand, if too much is included, the feel at impact may be too hard and unpleasant.

In addition to above components A to D, the rubber composition of the invention may optionally include also various additives. For example, sulfur, organosulfur compounds, inert fillers, antioxidants and zinc stearate may be included.

Preferred examples of inert fillers that may be used include zinc oxide, barium sulfate and calcium carbonate. These may be used singly or as combinations of two or more thereof.

The amount of inert filler included per 100 parts by weight of the base rubber may be set to preferably at least 1 part by weight, and more preferably at least 5 parts by weight. The upper limit in the amount of inert filler per 100 parts by weight of the base rubber may be set to preferably not more than 200 parts by weight, more preferably not more than 150 parts by weight, and even more preferably not more than 100 parts by weight. Too much or too little inert filler may make it impossible to achieve a proper weight and a good rebound.

The antioxidant used may be a known antioxidant. Examples include, but are not limited to, the commercial products Nocrac NS-6, Nocrac NS-30, Nocrac SP-N and Nocrac 200 (all available from Ouchi Shinko Chemical Industry Co., Ltd.). These may be used singly or as combinations of two or more thereof.

The amount of antioxidant included per 100 parts by weight of the base rubber serving as component A is set to preferably not more than 5 parts by weight, and more preferably not more than 3 parts by weight. Including too much may make a good rebound and a good durability impossible to achieve.

The rubber composition of the invention forms at least some portion of an integral part of a golf ball, which golf ball may take any of various forms according to the intended purpose. Illustrative examples include a one-piece golf ball formed entirely of the above rubber composition; a two-piece solid golf ball having a solid core and one cover layer, wherein at least some portion of the solid core and/or the cover is formed of the above composition; a multi-piece solid golf ball having a solid core of one or more layer and a cover of one or more layer, wherein at least some portion of the solid core and/or the cover is formed of the above composition; and a wound golf ball wherein at least some portion of the solid center and/or the cover is formed of the above composition. Of these various forms, a two-piece solid golf ball or a multi-piece solid golf ball having a solid core formed of the above composition is preferred.

When constructing a golf ball, examples of materials that may be used in portions of the golf ball other than the portion where the inventive rubber composition for golf balls is used include thermoplastic or thermoset polyurethane elastomers, polyester elastomers, ionomer resins, polyolefin elastomers and polyureas. One of these types may be used alone or two or more types may be used in admixture. The use of a thermoplastic polyurethane elastomer or an ionomer resin is especially preferred. A known process such as injection molding or compression molding may be used as the molding process.

Commercial products may be used as the thermoplastic polyurethane elastomer. Illustrative examples include Pandex T7298, Pandex T7295, Pandex T7890, Pandex TR3080, Pandex T8295, Pandex T8290 and Pandex T8260 (available from DIC Bayer Polymer, Ltd.). Commercial products may likewise be used as the ionomer resin. Illustrative examples include Surlyn 6320, Surlyn 8120 and Surlyn 9945 (available from E.I. DuPont de Nemours & Co.), and Himilan 1706, Himilan 1605, Himilan 1855, Himilan 1601 and Himilan 1557 (available from DuPont-Mitsui Polychemicals Co., Ltd.).

Polymers such as thermoplastic elastomers other than those mentioned above may be included as optional ingredients in the above materials. Examples of such other polymers include polyamide elastomers, styrene block elastomers, hydrogenated polybutadienes and ethylene-vinyl acetate (EVA) copolymers.

In cases where the golf ball manufactured using the rubber composition of the invention is a one-piece golf ball or a golf ball having a solid core or a solid center, the deflection of the one-piece golf ball or the solid core or solid center, when compressed under a final load of 1,275 N (130 kgf) from an initial load state of 98 N (10 kgf), although not subject to any particular limitation, is generally at least 2.0 mm, and preferably at least 2.5 mm. The upper limit is generally not more than 6.0 mm, and preferably not more than 5.8 mm. If the deflection is too small, the feel at impact may worsen and, particularly on long shots such as with a driver that cause a large ball deformation, the spin rate may rise excessively, resulting in a poor distance. On the other hand, if the one-piece golf ball or the solid core or solid center is too soft, the ball may have a deadened feel at impact and the rebound may be inadequate, possibly resulting in a poor distance, or the durability of the ball to cracking on repeated impact may worsen.

Here, the diameter of the solid core, although not subject to any particular limitation, may be set to generally at least 20 mm, and preferably at least 30 mm. The upper limit may be set to generally not more than 42.5 mm, and preferably not more than 42.3 mm.

The specific gravity of the solid core, although not subject to any particular limitation, may be set to generally at least 0.7, and preferably at least 0.9. The upper limit may be set to generally not more than 1.6, and preferably not more than 1.4.

The thickness per cover layer formed of the inventive golf ball composition and the above-described materials, although not subject to any particular limitation, may be set to generally at least 0.1 mm, and preferably at least 0.2 mm. The upper limit may be set to generally not more than 4 mm, and preferably not more than 3 mm.

When the rubber composition of the invention is used to produce one-piece golf balls, or the cores of two-piece solid golf balls and multi-piece solid golf balls, production may be carried out by effecting vulcanization and curing in the same way as with conventional rubber compositions for golf balls. The vulcanization conditions are exemplified by a vulcanization temperature of from 120 to 200° C. and a vulcanization time of from 10 to 50 minutes. By having the rubber composition include, in the above-indicated amount, the maleimide which serves as component C in the invention, as demonstrated in the subsequently described working examples and comparative examples, the vulcanization time can be shortened while maintaining a good performance, thereby enabling the efficiency of golf ball production to be effectively enhanced.

When manufacturing golf balls using the rubber composition of the invention, the diameter of the balls may be set to not less than 42 mm, and, according to the Rules of Golf for competitive play, preferably not less than 42.67 mm. The upper limit may be set to not more than 45 mm, and preferably not more than 44 mm. The weight may be set to not more than 48 g, and in particular, according to the Rules of Golf for competitive play, preferably not more than 45.93 g. The lower limit may be set to not less than 40 g, and preferably not less than 44 g.

### EXAMPLES

Examples of the invention and Comparative Examples are given below by way of illustration, and not by way of limitation.

### Examples 1 to 4, Comparative Examples 1 to 3

### Formation of Core

Rubber compositions were formulated as shown in Table 1, then molded and vulcanized at the vulcanization temperatures and times shown in the table, thereby producing cores having a diameter of 40.0 mm. Ingredient amounts in the table are indicated in parts by weight.

TABLE 1

| | Example | | | | Comparative Example | | |
|---|---|---|---|---|---|---|---|
| | 1 | 2 | 3 | 4 | 1 | 2 | 3 |
| BR01 | 95 | 95 | 95 | 95 | 95 | 95 | 95 |
| IR2200 | 5 | 5 | 5 | 5 | 5 | 5 | 5 |
| Methacrylic acid | 22.5 | 22.5 | 22.5 | 22.5 | 22.5 | 22.5 | 22.5 |
| Zinc oxide | 23 | 23 | 23 | 23 | 23 | 23 | 23 |
| Nocrac NS-6 | 0.2 | 0.2 | 0.2 | 0.2 | 0.2 | 0.2 | 0.2 |
| Vulnoc PM | 0.1 | 0.2 | 0.3 | 0.5 | 0 | 1 | 1.5 |
| Percumyl D | 1.1 | 1.1 | 1.1 | 1.1 | 1.1 | 1.1 | 1.1 |
| Vulcanization | 163 | 163 | 163 | 163 | 163 | 163 | 163 |
| temperature (° C.) | | | | | | | |
| Vulcanization time (min) | 23 | 22 | 22 | 21 | 24 | 19 | 16 |
| Productivity rating | Fair | Good | Good | Exc | — | Exc | Exc |
| Core deflection (mm) | 2.79 | 2.67 | 2.57 | 2.52 | 2.75 | 2.28 | 2.00 |
| Retention of performance rating | Good | Good | Good | Good | Good | NG | NG |

Details on the materials in Table 1 are given below.
BR01: A polybutadiene available from JSR Corporation; cis-1,4 bond content, 96% (published value from JSR Corporation)
IR2200: A polyisoprene available from JSR Corporation
Methacrylic acid: Available from Kuraray Co., Ltd.
Zinc oxide: Available from Sakai Chemical Co., Ltd.
Nocrac NS-6: An antioxidant available from Ouchi Shinko Chemical Industry Co., Ltd.; 2,2′-methylenebis(4-methyl-6-t-butylphenol)
Vulnoc PM: N,N′-m-phenylenebismaleimide, available from Ouchi Shinko Chemical Industry Co., Ltd.
Percumyl D: An organic peroxide available from NOF Corporation; dicumyl peroxide

The productivity and change in deflection (retention of performance) for each of the cores obtained were evaluated by the methods described below. The results are shown in Table 1.

### (1) Productivity:

The material was charged into a mold heated to the vulcanization temperature, and molding and vulcanization were carried out. The point at which the physical properties of the completed core become stable was treated as the conclusion of vulcanization, and demolding was begun at that time. The period of time from the start of such vulcanization up until demolding begins was measured as the vulcanization time, and the productivity was rated according to the following criteria in terms of the degree of shortening in the vulcanization time relative to Comparative Example 1.
Fair: The vulcanization time was shortened by at least 1 minute but less than 2 minutes
Good: The vulcanization time was shortened by at least 2 minutes but less than 3 minutes
Exc: The vulcanization time was shortened by at least 3 minutes

### (2) Change in Core Deflection (Retention of Performance):

The deflection (mm) by the core when compressed under a final load of 1,275 N (130 kgf) from an initial load state of 98 N (10 kgf) at a temperature of 23±1° C. and a rate of 10 mm/s was measured. Based on the results, the retention of performance was rated according to the following criteria.
NG: The change in deflection relative to Comparative Example 1 was ±0.3 mm or more
Good: The change in deflection relative to Comparative Example 1 was less than ±0.3 mm

As shown in Table 1, the rubber compositions in each of Examples 1 to 4, in which N,N′-m-phenylenebismaleimide was included in a range of from 0.1 to 0.5 parts by weight, were confirmed to have a shortened vulcanization time and thus an excellent productivity while retaining a good performance and good properties (deflection) comparable to those in Comparative Example 1. By contrast, in Comparative Examples 2 and 3, where the amount of N,N′-m-phenylenebismaleimide compounded was more than 0.5 part by weight, a shortening in the vulcanization time was achieved, but large changes in the deflection arose, making it impossible to retain a good performance and good properties.

Japanese Patent Application No. 2011-274101 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A rubber composition for golf balls, comprising:
(A) a polybutadiene-containing base rubber;
(B) methacrylic acid; and
(C) a maleimide,
wherein component C is included in an amount of from 0.1 to 0.5 part by weight per 100 parts by weight of component A.

2. The rubber composition of claim 1, wherein the maleimide serving as component C is a monomaleimide of general formula (1) below 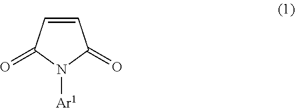
or a bismaleimide of general formula (2) below 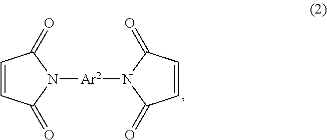
wherein Ar¹ is a hydrogen atom or an aryl group, and Ar² is an arylene group.

3. The rubber composition of claim 2, wherein the maleimide of component C is N,N′-m-phenylenebismaleimide.

4. The rubber composition of claim 1, further comprising, as a crosslinking agent:
(D) an organic peroxide.

5. The rubber composition of claim 1 which is adapted for use in forming a golf ball core or a one-piece golf ball.

6. A method of manufacturing golf balls, comprising the step of molding and vulcanizing, for a vulcanization time, a rubber composition which includes (A) a polybutadiene-containing base rubber and (B) methacrylic acid so as to obtain a golf ball core or a one-piece golf ball, wherein the vulcanization time during molding and vulcanization is shortened by including in the rubber composition (C) from 0.1 to 0.5 part by weight of a maleimide per 100 parts by weight of component A.

7. The manufacturing method of claim 6, wherein the maleimide serving as component C is a monomaleimide of general formula (1) below 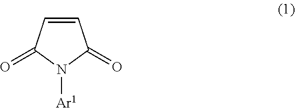
or a bismaleimide of general formula (2) below 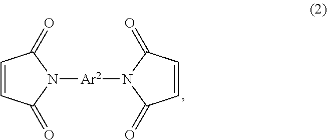
wherein Ar¹ is a hydrogen atom or an aryl group, and Ar² is an arylene group.

8. The manufacturing method of claim 7, wherein the maleimide of component C is N,N′-m-phenylenebismaleimide.

9. The manufacturing method of claim 6, wherein the rubber composition further includes, as a crosslinking agent, (D) an organic peroxide.
